(19) United States
(12) Patent Application Publication
(10) Pub. No.: US 2021/0001304 A1
(43) Pub. Date: Jan. 7, 2021

(54) Photon Induced Molecular Change

(71) Applicant: Kevin Brian Delahoussaye, Las Cruces, NM (US)

(72) Inventor: Kevin Brian Delahoussaye, Las Cruces, NM (US)

(21) Appl. No.: 16/502,939

(22) Filed: Jul. 3, 2019

(51) Int. Cl. B01J 19/12

(52) U.S. Cl. CPC B01J 19/12; B01J 2219/12

(57) ABSTRACT

In a practical application. Particles around a larger mass of particles will be more entangled with each other than particles that are out on their own. Therefore, on a plane with more particles the particles examined will be more greatly entangled and corresponding actions on these particles will change corresponding action from the particles already entangled with the atoms in question.

### CROSS REFERENCE TO RELATED APPLICATIONS

Not Applicable

### REGARDING FEDERALLY SPONSORED RESEARCH OR DEVELOPMENT

Not Applicable

### REGARDING THE NAMES OF THE PARTIES TO A JOINT RESEARCH AGREEMENT

Not Applicable

### INCORPORATION BY REFERENCE OF MATERIAL SUBMITTED ON A COMPACT DISC OR AS A TEXT FILE VIA THE OFFICE ELECTRONIC FILING SYSTEM (EFS-WEB):

### STATEMENT REGARDING PRIOR DISCLOSURES BY THE INVENTOR OR A JOINT INVENTOR

Not Applicable

### BACKGROUND OF INVENTION

In a practical application. Particles around a larger mass of particles will be more entangled with each other than particles that are out on their own. Therefore, on a plane with more particles the particles examined will be more greatly entangled and corresponding actions on these particles will change corresponding action from the particles already entangled with the atoms in question.

### BRIEF SUMMARY OF INVENTION

A problem exists explaining the action of gravity. In a practical application. Particles around a larger mass of particles will be more entangled with each other than particles that are out on their own. On a plane with more particles the particles examined will be more greatly entangled and corresponding actions on these particles will change corresponding action from the particles already entangled with the atoms in question.

Particles around an array of photons which engage in the action of entangling the particles with each other as much as is desired. This entanglement creates a situation where an act on one particle creates a subsequent action on the particle entangled with it. With enough entangled particles a “pull” is created within the field where the particles are entangled as one action on a particle creates an action on the others.

### SEQUENCE LISTING

Not Applicable

1. Particles around an array of photons which engage in the action of entangling the particles with each other as much as is desired.

2. This entanglement creates a situation where an act on one particle creates a subsequent action on the particle entangled with it.

3. Desired entanglement of particles; a “pull” is created within the field where the particles are entangled as one action on a particle creates an action on the others.
